(19) United States
(12) Patent Application Publication
(10) Pub. No.: US 2017/0316438 A1
(43) Pub. Date: Nov. 2, 2017

(54) CUSTOMER EXPERIENCE ANALYTICS

(71) Applicant: Genesys Telecommunications Laboratories, Inc., Daly City, CA (US)

(72) Inventors: Yochai Konig, San Francisco, CA (US); Ron Harlev, San Francisco, CA (US)

(21) Appl. No.: 15/143,274

(22) Filed: Apr. 29, 2016

(51) Int. Cl. G06Q 30/02; H04M 3/51

(52) U.S. Cl. CPC G06Q 30/0204; G06Q 30/0201; H04M 3/51

(57) ABSTRACT

A method for generating a predictor of customer behavior for a contact center includes: collecting, by a processor, data from a plurality of different applications of the contact center, the data being stored in a plurality of different formats, the data corresponding to a plurality of recorded interactions between a plurality of customers and the contact center; converting, by the processor, the data from the plurality of different formats into a common format; generating, by the processor, a plurality of customer models for the customers by, for each customer of the customers: identifying, from the data from the plurality of different applications, identified data associated with the customer; and aggregating the identified data in an individual customer model of the plurality of customer models, the individual customer model being associated with the customer; and generating, by the processor, a predictor in accordance with the customer models.

### FIELD

Aspects of embodiments of the present invention relate to the field of software for operating contact centers, in particular, software for monitoring and controlling the operation of the contact center in accordance with the analytics.

### BACKGROUND

Generally, a contact center is staffed with agents who serve as an interface between an organization, such as a company, and outside entities, such as customers. For example, human sales agents at contact centers may assist customers in making purchasing decisions and may receive purchase orders from those customers. Similarly, human support agents at contact centers may assist customers in solving problems with products or services provided by the organization. Interactions between contact center agents and outside entities (customers) may be conducted by speech voice (e.g., telephone calls or voice over IP or VoIP calls), video (e.g., video conferencing), text (e.g., emails and text chat), or through other media.

Different contact centers may often have different requirements in terms of, for example, size, staffing, physical hardware, and software services due to differences in, for example, the volume of traffic received by the contact center, the nature of the traffic (e.g., phone calls, emails, text chat), the typical durations or lengths of interactions between agents and customers, and subject matter of the interactions (e.g., sales, customer service, and technical support). Furthermore, these requirements may change over time, in accordance with, for example, the time of day, day of the week, season of the year, or based on events such as the launch of a new product offering, a change in operating policies of the organization, and external forces (e.g., severe weather affecting normal operations).

### SUMMARY

Aspects of embodiments of the present invention are directed to systems and methods for collecting customer experience analytics data within a contact center and to guide control of aspects of the contact center in accordance with the collected customer experience analytics data.

According to one embodiment of the present invention, a method for generating a predictor of customer behavior for a contact center includes: collecting, by a processor, data from a plurality of different applications of the contact center, the data being stored in a plurality of different formats, the data corresponding to a plurality of recorded interactions between a plurality of customers and the contact center; converting, by the processor, the data from the plurality of different formats into a common format; generating, by the processor, a plurality of customer models for the customers by, for each customer of the customers: identifying, from the data from the plurality of different applications, identified data associated with the customer; and aggregating the identified data in an individual customer model of the plurality of customer models, the individual customer model being associated with the customer; and generating, by the processor, a predictor in accordance with the customer models.

The predictor may be a deep neural network, and training the predictor in accordance with the customer models may include: calculating, for each of the customer models, a plurality of features; identifying a target feature among the plurality of features; generating training data, the training data including a plurality of examples, wherein each of the examples may include: a plurality of input features corresponding to the plurality of features without the target feature; and at least one output feature corresponding to the target feature; and training the deep neural network in accordance with the training data by applying a back propagation algorithm.

The generating the plurality of customer models for the customers may further include, for each customer of the customers, generating a plurality of features in accordance with the identified data.

The method may further include generating, by the processor, an aggregate customer model by: identifying one or more individual customer models associated with a group; and aggregating the one or more individual customer models to generate the aggregated customer model.

The method may further include: receiving, by the processor, additional data from one of the plurality of different applications of the contact center; converting, by the processor, the additional data into the common format; updating, by the processor, at least one of the plurality of customer models in accordance with the additional data to compute at least one updated customer model; and updating, by the processor, the predictor in accordance with the at least one updated customer model.

According to one embodiment of the present invention, a method for configuring a contact center includes: supplying, by a processor, one or more customer models to a predictor, each of the one or more customer models including data collected from a plurality of different applications of the contact center; computing, by the processor, an expected characteristic of future interactions in accordance with the one or more customer models; and computing, by the processor and in accordance with the expected characteristic of future interactions, at least one configuration parameter for configuring an application of the different applications of the contact center.

The predictor may be a deep neural network.

The customer models may be generated by: collecting, by the processor, data from the plurality of different applications of the contact center, the data being stored in a plurality of different formats, the data corresponding to a plurality of recorded interactions between a plurality of customers and the contact center; converting, by the processor, the data from the plurality of different formats into a common format; and generating, by the processor, the customer models for the customers by, for each customer of the customers: identifying, from the data from the plurality of different applications, identified data associated with the customer; and aggregating the identified data in an individual customer model of the customer models, the individual customer model being associated with the customer.

The one or more customer models may include an aggregated customer model, the aggregated customer model being generated by: identifying a group of one or more individual customer models of the individual customer models; and aggregating the group of one or more individual customer models to generate the aggregated customer model.

The method may further include: receiving, by the processor, additional data from one of the plurality of different applications of the contact center; converting, by the processor, the additional data into the common format; updating, by the processor, at least one of the one or more customer models in accordance with the additional data to compute at least one updated customer model; and updating, by the processor, the predictor in accordance with the at least one updated customer model.

The computing the at least one configuration parameter for configuring the application of the different applications of the contact center may further include computing the at least one configuration parameter in accordance with a plurality of agent models, each of the agent models including data collected from the plurality of different applications of the contact center.

The plurality of agent models may be generated by: collecting, by the processor, data from a plurality of different applications of the contact center, the data being stored in a plurality of different formats, the data corresponding to a plurality of recorded interactions between a plurality of agents of the contact center and a plurality of customers; converting, by the processor, the data from the plurality of different formats into a common format; and generating, by the processor, the plurality of agent models for the agents by, for each agent of the agents: identifying, from the data from the plurality of different applications, identified data associated with the agent; and aggregating the identified data in an individual agent model of the plurality of agent models, the individual agent model being associated with the agent.

The plurality of agent models may include an aggregate agent model, the aggregated agent model being generated by: identifying a group of one or more individual agent models of the individual agent models; and aggregating the group of one or more individual agent models to generate the aggregated agent model.

Each of the plurality of agent models may include a first call resolution rate, an average handling time, and a customer satisfaction rating.

According to one embodiment of the present invention, in a system for operating a contact center including a plurality of different applications, the system includes: a processor; and a memory, wherein the memory stores instructions that, when executed by the processor, cause the processor to: supply one or more customer models to a predictor, each of the one or more customer models including data collected from the plurality of different applications; compute an expected characteristic of future interactions in accordance with the one or more customer models; and compute, in accordance with the expected characteristic of future interactions, at least one configuration parameter for configuring an application of the applications of the contact center.

The predictor may be a deep neural network.

The memory may further store instructions that, when executed by the processor, cause the processor to generate the customer models by: collecting data from the plurality of different applications of the contact center, the data being stored in a plurality of different formats, the data corresponding to a plurality of recorded interactions between a plurality of customers and the contact center; converting the data from the plurality of different formats into a common format; and generating the customer models for the customers by, for each customer of the customers: identifying, from the data from the plurality of different applications, identified data associated with the customer; and aggregating the identified data in an individual customer model of the customer models, the individual customer model being associated with the customer.

The one or more customer models may include an aggregated customer model, the aggregated customer model being generated by: identifying a group of one or more individual customer models of the individual customer models; and aggregating the group of one or more individual customer models to generate the aggregated customer model.

The memory may further store instructions that, when executed by the processor, cause the processor to: receive additional data from one of the plurality of different applications of the contact center; convert the additional data into the common format; update at least one of the one or more customer models in accordance with the additional data to compute at least one updated customer model; and update the predictor in accordance with the at least one updated customer model.

The memory may further store instructions that, when executed by the processor, cause the processor to compute the at least one configuration parameter for configuring the application of the different applications of the contact center by computing the at least one configuration parameter in accordance with a plurality of agent models, each of the agent models including data collected from the plurality of different applications of the contact center.

The memory may further store instructions that, when executed by the processor, cause the processor to generate the plurality of agent models by: collecting, by the processor, data from a plurality of different applications of the contact center, the data being stored in a plurality of different formats, the data corresponding to a plurality of recorded interactions between a plurality of agents of the contact center and a plurality of customers; converting the data from the plurality of different formats into a common format; and generating the plurality of agent models for the agents by, for each agent of the agents: identifying, from the data from the plurality of different applications, identified data associated with the agent; and aggregating the identified data in an individual agent model of the plurality of agent models, the individual agent model being associated with the agent.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic block diagram of a system for supporting a contact center in providing contact center services according to one exemplary embodiment of the invention.

FIG. 2A is a schematic block diagram of a customer experience analytics module according to one embodiment of the present invention.

FIG. 2B is a schematic diagram illustrating the interaction of the components of a customer experience analytics system as described above according to one embodiment of the present invention.

FIG. 2C is a schematic diagram illustrating the interaction of the components of a customer experience analytics system while running as described above according to one embodiment of the present invention.

FIG. 3 is a flowchart illustrating a method for generating application settings based on collected data according to one embodiment of the present invention.

FIGS. 4A and 4B are flowcharts illustrating a method for generating customer and agent models and aggregated customer and agent models according to one embodiment of the present invention.

FIG. 5 is a flowchart illustrating a method for generating predictors according to one embodiment of the present invention.

FIG. 6 is a flowchart illustrating a method for forecasting behavior using the predictors according to one embodiment of the present invention.

FIG. 7A is a block diagram of a computing device according to an embodiment of the present invention.

FIG. 7B is a block diagram of a computing device according to an embodiment of the present invention.

FIG. 7C is a block diagram of a computing device according to an embodiment of the present invention.

FIG. 7D is a block diagram of a computing device according to an embodiment of the present invention.

FIG. 7E is a block diagram of a network environment including several computing devices according to an embodiment of the present invention.

### DETAILED DESCRIPTION

Analytics refers to the study of data to identify patterns. For example, data collected on the behavior of website users, such as the proportion of time spent on various pages of a the website, time spent on any particular page, fractions of users working through a multiple step flow (e.g., a wizard or checkout process) may all be used to identify typical patterns of user behavior. This analytics data can then be used to identify ways to modify the system to improve the experiences of users of the website. As another example, analytics data may be collected on callers who interact with contact centers, for example, through interactive voice response (IVR) systems that provide voice responses to touch tone commands and through human agents at the contact center.

Generally speaking, however data collected by different analytics systems are separated or “siloed” from each other. For example, data collection systems associated with the website (e.g., collected by embedded scripts that run in a user's web browser sending information to an analytics server) are generally separate from the data collection systems associated with the contact center (e.g., collected by a statistics server, which receives information such as caller wait time, call abandonment events, caller survey responses). For example, workforce management (WFM) configurations can be modified based on information collected via speech analytics (see, e.g., U.S. patent application Ser. No. 14/320,237 “Enhancing Work Force Management with Speech Analytics”, filed in the United States Patent and Trademark Office on Jun. 30, 2014, the entire disclosure of which is incorporated by reference herein).

Embodiments of the present invention are directed to predictive customer experience (CX) applications to perform personalized customer experiences to various users based on customer models and agent models (or profiles) that are constructed from analytics data collected from a range of different applications associated with the system. These customer models and agent models can also be used to automatically provision, tune, and optimize the various applications.

### Contact Center Overview

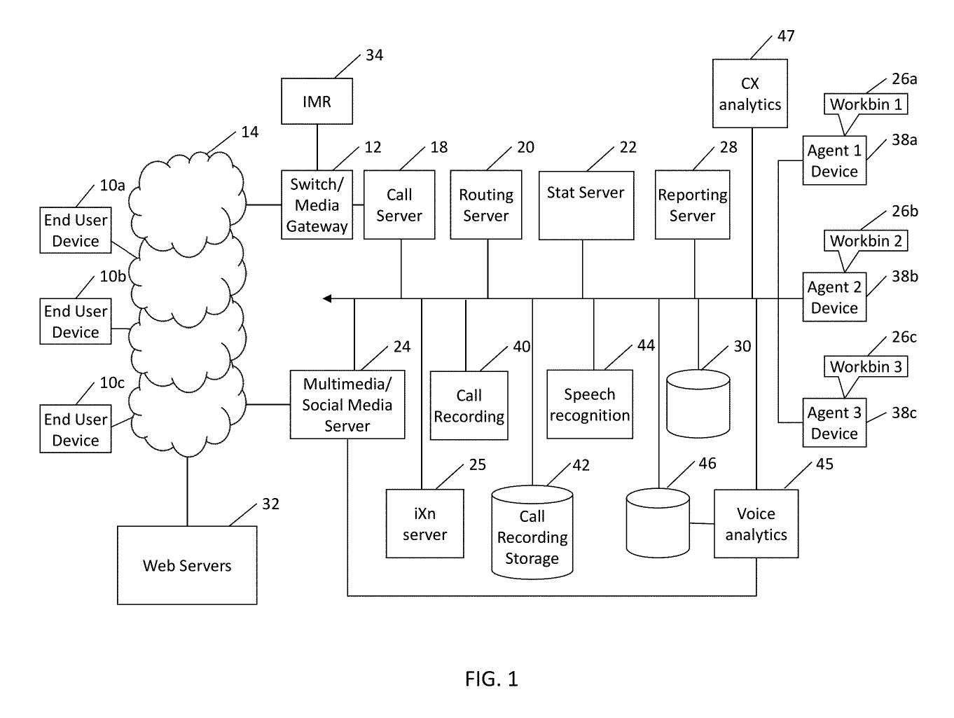

FIG. 1 is a schematic block diagram of a system for supporting a contact center in providing contact center services according to one exemplary embodiment of the invention. For the purposes of the discussion herein, interactions between customers using end user devices 10 and agents at a contact center using agent devices 38 may be recorded by call recording module 40 and stored in call recording storage 42. The recorded calls may be processed by speech recognition module 44 to generate recognized text which is stored in recognized text storage 46. In some embodiments of the present invention, a voice analytics module 45 configured to perform analytics on recognized speech data such as by detecting events occurring in the interactions and categorizing the interactions in accordance with the detected events. Aspects of speech analytics systems are described, for example, in U.S. patent application Ser. No. 14/586,730 “System and Method for Interactive Multi-Resolution Topic Detection and Tracking,” filed in the United States Patent and Trademark Office on Dec. 30, 2014, the entire disclosure of which is incorporated herein by reference. Embodiments of the present invention may also include a customer experience (CX) analytics module 47, which will be described in more detail below.

The contact center may be an in-house facility to a business or corporation for serving the enterprise in performing the functions of sales and service relative to the products and services available through the enterprise. In another aspect, the contact center may be a third-party service provider. The contact center may be deployed in equipment dedicated to the enterprise or third-party service provider, and/or deployed in a remote computing environment such as, for example, a private or public cloud environment with infrastructure for supporting multiple contact centers for multiple enterprises. The various components of the contact center system may also be distributed across various geographic locations and computing environments and not necessarily contained in a single location, computing environment, or even computing device.

According to one exemplary embodiment, the contact center system manages resources (e.g., personnel, computers, and telecommunication equipment) to enable delivery of services via telephone or other communication mechanisms. Such services may vary depending on the type of contact center, and may range from customer service to help desk, emergency response, telemarketing, order taking, and the like.

Customers, potential customers, or other end users (collectively referred to as customers) desiring to receive services from the contact center may initiate inbound telephony calls to the contact center via their end user devices 10a-10c (collectively referenced as 10). Each of the end user devices 10 may be a communication device conventional in the art, such as, for example, a telephone, wireless phone, smart phone, personal computer, electronic tablet, and/or the like. Users operating the end user devices 10 may initiate, manage, and respond to telephone calls, emails, chats, text messaging, web-browsing sessions, and other multi-media transactions.

Inbound and outbound telephony calls from and to the end users devices 10 may traverse a telephone, cellular, and/or data communication network 14 depending on the type of device that is being used. For example, the communications network 14 may include a private or public switched telephone network (PSTN), local area network (LAN), private wide area network (WAN), and/or public wide area network such as, for example, the Internet. The communications network 14 may also include a wireless carrier network including a code division multiple access (CDMA) network, global system for mobile communications (GSM) network, or any wireless network/technology conventional in the art, including but to limited to 3G, 4G, LTE, and the like.

According to one exemplary embodiment, the contact center includes a switch/media gateway 12 coupled to the communications network 14 for receiving and transmitting telephony calls between end users and the contact center. The switch/media gateway 12 may include a telephony switch configured to function as a central switch for agent level routing within the center. The switch may be a hardware switching system or a soft switch implemented via software. For example, the switch 12 may include an automatic call distributor, a private branch exchange (PBX), an IP-based software switch, and/or any other switch configured to receive Internet-sourced calls and/or telephone network-sourced calls from a customer, and route those calls to, for example, an agent telephony device. In this example, the switch/media gateway establishes a voice path/connection (not shown) between the calling customer and the agent telephony device, by establishing, for example, a connection between the customer's telephony device and the agent telephony device.

According to one exemplary embodiment of the invention, the switch is coupled to a call server 18 which may, for example, serve as an adapter or interface between the switch and the remainder of the routing, monitoring, and other call-handling components of the contact center.

The call server 102 may be configured to process PSTN calls, VoIP calls, and the like. For example, the call server 102 may include a session initiation protocol (SIP) server for processing SIP calls. According to some exemplary embodiments, the call server 102 may, for example, extract data about the customer interaction such as the caller's telephone number, often known as the automatic number identification (ANI) number, or the customer's internet protocol (IP) address, or email address, and communicate with other CC components and/or CC iXn controller 18 in processing the call.

According to one exemplary embodiment of the invention, the system further includes an interactive media response (IMR) server 34, which may also be referred to as a self-help system, virtual assistant, or the like. The IMR server 34 may be similar to an interactive voice response (IVR) server, except that the IMR server is not restricted to voice, but may cover a variety of media channels including voice. Taking voice as an example, however, the IMR server may be configured with an IMR script for querying calling customers on their needs. For example, a contact center for a bank may tell callers, via the IMR script, to “press 1” if they wish to get an account balance. If this is the case, through continued interaction with the IMR, customers may complete service without needing to speak with an agent. The IMR server 34 may also ask an open ended question such as, for example, “How may I assist you?” and the customer may speak or otherwise enter a reason for contacting the contact center. The customer's speech may then be processed by the speech recognition module 44 and the customer's response may then be used by the routing server 20 to route the call to an appropriate contact center resource.

In more detail, a speech driven IMR receives audio containing speech from a user. The speech is then processed to find phrases and the phrases are matched with one or more speech recognition grammars to identify an action to take in response to the user's speech. As used herein, the term “phrases” may also include “fragments” in which words are extracted from utterances that are not necessarily sequential. As such, the term “phrase” includes portions or fragments of transcribed utterances that omit some words (e.g., repeated words and words with low saliency such as “um” and “ah”). For example, if a user says “what is my account balance?” then the speech driven IMR may attempt to match phrases detected in the audio (e.g., the phrase “account balance”) with existing grammars associated with actions such as account balance, recent transactions, making payments, transferring funds, and connecting to a human customer service agent. Each grammar may encode a variety of ways in which customers may request a particular action. For example, an account balance request may match phrases such as “account balance,” “account status,” “how much money is in my accounts,” and “what is my balance.” Once a match between the spoken phrase from the user and a grammar is detected, the action associated with the grammar is performed in a manner similar to the receiving a user selection of an action through a keypress. These actions may include, for example, a VoiceXML response that is dynamically generated based on the user's request and based on stored business information (e.g., account balances and transaction records).

In some embodiments, the speech recognition module 44 may also operate during a voice interaction between a customer and a live human agent in order to perform analytics on the voice interactions. During a voice interaction, audio containing speech from the customer and speech from the human agent (e.g., as separate audio channels or as a combined audio channel) may be processed by the speech recognition module 44 to identify words and phrases uttered by the customer and/or the agent during the interaction. In some embodiments of the present invention, a different speech recognition modules are used for the IMR and for performing voice analytics of the interactions (e.g., the speech recognition module may be configured differently for the IMR as compared to the voice interactions, due, or example, to differences in the range of different types of phrases expected to be spoken in the two different contexts).

In some embodiments, the routing server 20 may query a customer database, which stores information about existing clients, such as contact information, service level agreement (SLA) requirements, nature of previous customer contacts and actions taken by contact center to resolve any customer issues, and the like. The database may be, for example, Cassandra or any non-SQL database, and may be stored in a mass storage device 30. The database may also be a SQL database an may be managed by any database management system such as, for example, Oracle, IBM DB2, Microsoft SQL server, Microsoft Access, PostgreSQL, MySQL, FoxPro, and SQLite. The routing server 20 may query the customer information from the customer database via an ANI or any other information collected by the IMR server 34.

According to one exemplary embodiment of the invention, the mass storage device(s) 30 may store one or more databases relating to agent data (e.g., agent profiles, schedules, etc.), customer data (e.g., customer profiles), interaction data (e.g., details of each interaction with a customer, including reason for the interaction, disposition data, time on hold, handle time, etc.), and the like. According to one embodiment, some of the data (e.g., customer profile data) may be maintained in a customer relations management (CRM) database hosted in the mass storage device 30 or elsewhere. The mass storage device may take form of a hard disk or disk array as is conventional in the art.

### Customer Experience Analytics

Aspects of embodiments of the present invention are directed to systems and methods for performing analytics on interaction data from a plurality of different data sources such as different applications associated with a contact center or an organization. Aspects of embodiments of the present invention are also directed to generating, updating, and modifying behavior models based on the collected interaction data. The behavior models may include models of customers and models of agents. The behavior models may be used to predict behaviors of, for example, customers and/or agents, in a variety of situations, thereby allowing embodiments of the present invention to tailor interactions based on the predictions or to allocate resources in preparation for predicted characteristics of future interactions, and thereby improving overall performance, including improving the customer experience.

Embodiments of the present invention will be described below in the context of a contact center. However, embodiments of the present invention are not limited thereto and may also be applied in other circumstances in which large amounts of data on interactions and transactions.

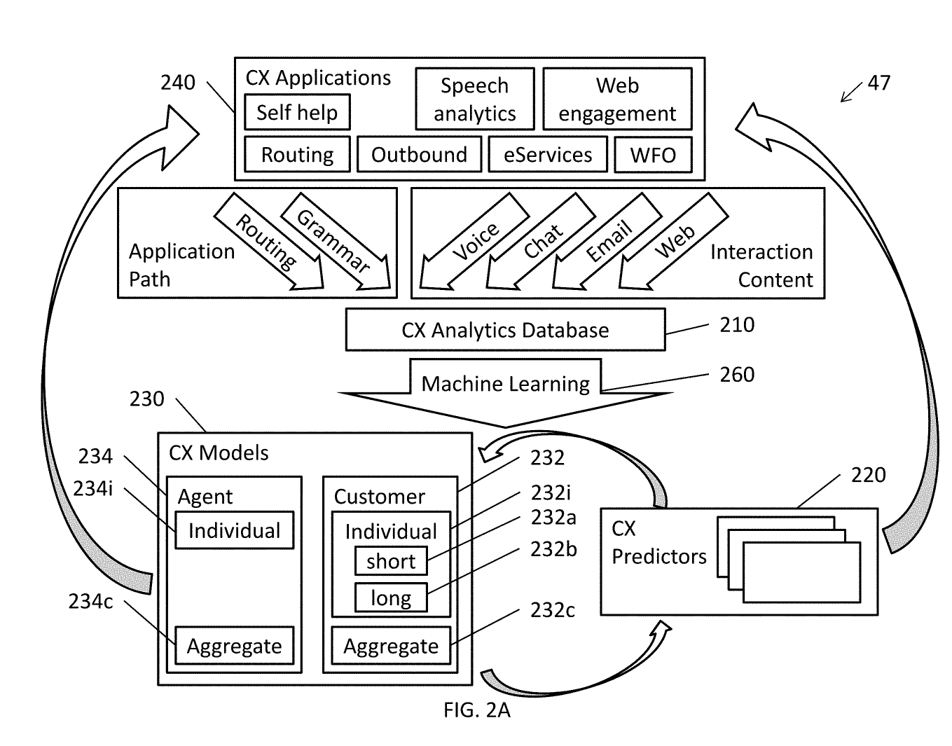

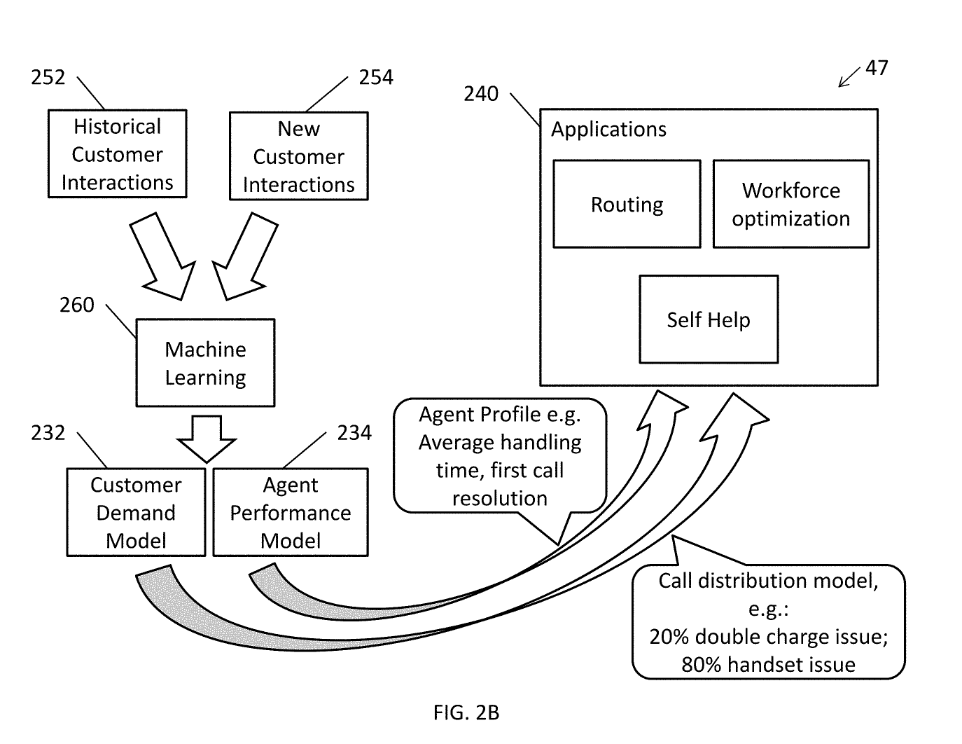

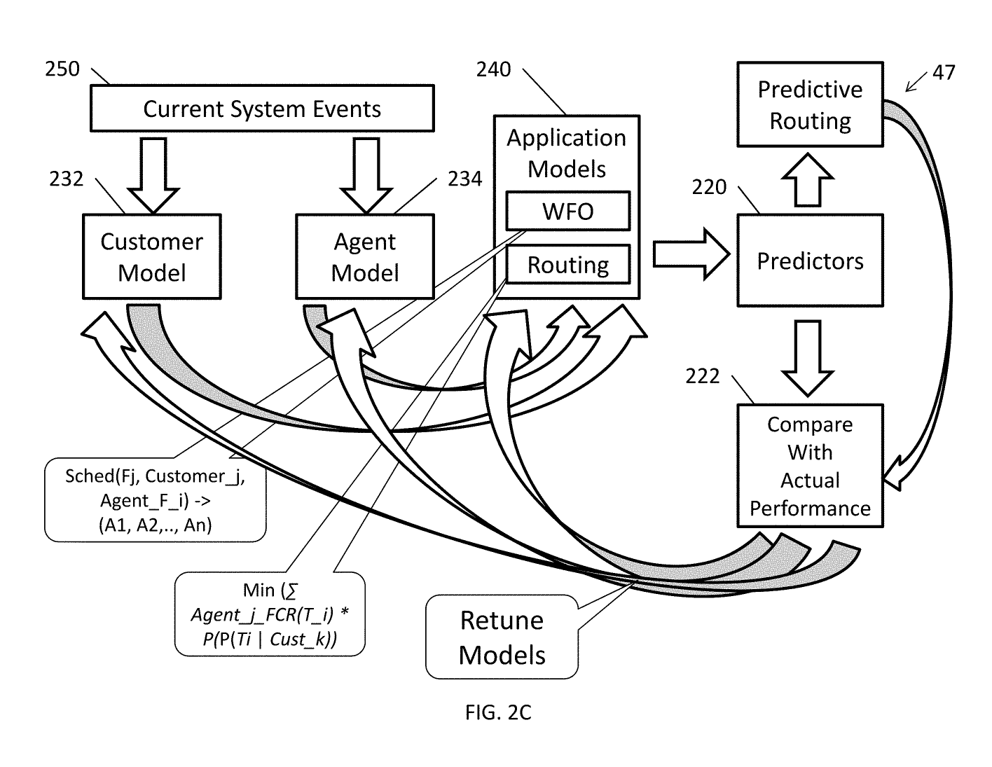

Referring to FIG. 2A, according to one embodiment of the present invention, there are four main modules or components to the system. First, a customer experience analytics database 210 collects or stores all of the interaction data from all various applications 240 at the contact center and can deliver this data for use in training (e.g., by applying machine learning techniques 260) the customer experience (CX) predictors 220 and the customer experience (CX) models 230. This data may include interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center).

Second, customer experience (CX) models 230 are used to model or profile customers and agents. For example, the customer models 232 include individual customer models 232i (both short term 232a and long term 232b) and aggregated customer models 232c. The aggregated customer models 232c may also include long term and short term models (e.g., one hour, two week, six month, one year, etc.). Similarly, the agent models 234 may include individual agent models 234i and aggregated agent models 234c. The customer models 232 store all available information about customers and enable the customer experience predictors 220 to make predictions of customer state and next actions. Similarly, the agent models 234 store all available information about agents to enable the customer experience predictors 220 to make predictions of agent performance characteristics, as shown by the arrow from the CX models 230 to the predictors 220.

In more detail, the customer experience models 230 include agent models 234, (which include individual agent models 234i and aggregated agent models 234c) and customer models 232 (which include individual customer models 232i and aggregated customer models 232c).

Each of the individual agent models 234i corresponds to one of the agents of the contact center and may contain information about that agent's performance such as first contact (or first call) resolution rate, average handling time, sales performance, and customer satisfaction across various call topics and across various classes of customers (e.g., based on customer call profile, customer model, and demographics). In some embodiments of the present invention, the individual agent models 234i also contain other information related to agent satisfaction such as agent business (or idle time or idle percentage), issue difficulty, and co-workers assigned on the agent's shift.

The aggregated agent models 234c are aggregations of the individual agent models 234i, such as aggregations of the performance information of the agents. These aggregated agent models 234c may correspond to different groups of agents, such as the agents of a current shift, the agents at a particular location, agents having a particular combination of skills, or the entire population of agents of the organization.

Each of the individual customer models 232i includes all of the information about the customer's past interactions with the contact center or organization. A customer experience predictor (or prediction model) 220 may use the individual customer models 232i to compute probability distributions regarding the customer's current state (e.g., the probability that the customer ready to buy another product, the probability that the customer is going to cancel membership, or the probability that the customer is angry) and probability distributions regarding future interactions or the customer's future behavior (e.g., will the customer renew his or her subscription next month, will the customer contact next week to purchase a new product, will the customer contact the support line tomorrow). The individual customer models 232i may also be used to identify specific agent models 234i or types of agents that would be best suited to resolve various issues. For example, some customers may identify better with agents who take a more direct approach in directly solving issues while other customers appreciate more time spent listening to the customer complaints and apologizing for mistakes in performance.

Like the aggregated agent models 234c, the aggregated customer models 232c are aggregations of individual customer models 232i and the past interactions associated with the individual customer models 232i that are included in any one of the aggregated customer models 232c. These aggregated customer models 232c may be grouped based on various characteristics such as living in particular geographic areas, customer loyalty program status (e.g., platinum members of the loyalty club), customer tier (e.g., paying extra for higher service levels), and product line (e.g., personal computers versus smartphones).

The third main module of the system, customer experience predictors 220, are used to compute predictions such as the probability that a customer will contact the organization in various timeframes for various reasons, including probabilities computed for every communication channel to the contact center (e.g., telephone, email, text chat). Customer experience predictors 220 may also be used to compute probabilities of other events, such as the probability that a particular customer or a group of customers will accept a sales offer. The customer experience predictors 220 may compute these probability distributions based on a number of different circumstances such as the channel on which the offer is communicated (e.g., by a telephone, an email, or paper mail). These predictors 220 can be used to predict an overall aggregated customer interaction volume, and agent models 234 can be used to predict first contact resolution rates for the various possible call reasons.

Fourth, customer experience application models 240 are used to model the activities of the various applications within the contact center. These applications, may include, workforce optimization (WFO) including workforce management (WFM), self-help (e.g., customer automated help systems), routing, eServices, speech analytics, outbound interactions, and web engagement. The customer experience application models 240 includes a model for each application of the contact center. The application models are created by specialists in the applications, for instance, a specialist in agent scheduling would create a function or model that would serve to assign and schedule agents. At least some of the independent variables (e.g., input variables) of the application model or function are the outputs or predictions of customer and agent models. For each of these application models 240, embodiments of the present invention can compute settings for the application based on the given relevant agent and customer models 232 and 234 and the CX predictors 2202, as shown by the arrows from the CX predictors 220 and the CX models 230 to the application models 240. For example, routing strategies can be tuned based on the predicted call volume in particular topics and based on agent performance characteristics. For example, if the prediction models 220 predict a large increase in call volume due to significant changes in a product operating system, then a routing strategy may need to be updated to route those interactions to a specific group of agents that are capable of handling this issue (in a manner similar to the agent scheduling application, also known as workforce management (WFM) for scheduling an adequate number of agents to handle the forecast volume), if current agent performance indicates that the current set of agents assigned to the topics will not be able to handle the expected call volume.

FIG. 2B is a schematic diagram illustrating the interaction of the components of a customer experience analytics system as described above according to one embodiment of the present invention. As discussed above, data from applications, including historical customer interactions 252 and new customer interactions 254 are supplied to a machine learning process 260 (e.g., implemented in customer experience analytics module 47) to generate customer models 232 and agent models 234. The customer models 232 and agent models 234 (e.g., including the aggregated models) are then used to make predictions that are then used to generate new configuration settings for applications such as routing, workforce optimization (WFO) or workforce management (WFM), and self help.

FIG. 2C is a schematic diagram illustrating the interaction of the components of a customer experience analytics system while running as described above according to one embodiment of the present invention. As shown in FIG. 2C, while the contact center is running (e.g., handling interactions between customers and agents), the customer models 232 and the agent models 234 are updated (e.g., periodically or continuously updated) based on additional data from current system events 250 such as information collected from new customer interactions 254 (e.g., analytics data from interactions that occurred after the last update or updating the models with new information when each interaction is completed or in response to each interaction being completed), to compute or generate updated customer models 232 and/or updated agent models 234. In every interaction of a customer with an enterprise, one or more system events are generated. For instance, when a customer interacts with a speech enabled self-help system (during a “self-help phase”) and eventually gets transferred to a human operator, the customer phrases and dialogue are recorded including his or her call reasons, and including the outcome that the customer issue wasn't resolved during the self-help phase. Furthermore the customer dialogue with the human agent is linked to his self-help session. The updated customer models 232 and agent models 234 may be used to update the application models 240, which are used to compute or generate updated predictors 220. The performance of the predictions made by the predictors 220 is compared with actual performance 222 (e.g., retrieved from interaction records maintained in the mass storage device 30). In the example of FIG. 2C, predictions as to which agent to route interactions to are compared with actual routing performance (e.g., whether the customer had to be transferred to another agent due to an initial routing error). The comparisons of routing predictions with actual performance may be used to further update the customer models 232 and the agent models 234 (e.g., adjusting a customer model 232 based on what the actual interaction reason was).

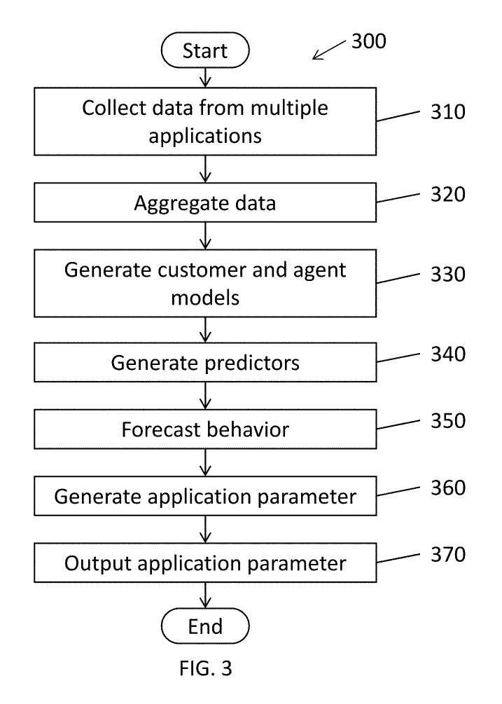

FIG. 3 is a flowchart illustrating, in more detail, a method for generating application settings in based on collected data according to one embodiment of the present invention. The operations of FIG. 3 may be performed, for example, by the CX analytics module 47 shown in FIG. 1 and FIG. 2, which may be executed by one or more general purpose computers. Referring to FIG. 3, in operation 310, the CX analytics module 47 collects data from multiple applications. These multiple applications may include the various applications or modules running on various servers as shown in FIG. 1, such as the routing server 20, the stat server 22, the multimedia/social media server 24, the web servers 32, the IMR 34, and the voice analytics module 45.

In operation 320, the data collected from the various applications is aggregated. This aggregation operation may include, for example, converting the data from the native formats of the individual applications to an internal format of the CX analytics module 47 (e.g., using a data format conversion module tailored for each application), normalizing the units of the various data to a standard set of units (e.g., normalizing data to events per minute, where the original data may have been stored as events per day or minutes per event), accumulating or averaging values, identifying events (e.g., interactions tagged as being of a particular category or containing a particular detected event such as an issue resolved event or a supervisor escalation event), and merging customer interaction data from interactions with different portions of the contact center (e.g., a customer has initial interactions to attempt to solve a problem using a self-help website, then emails technical support regarding the same problem, and finally calls technical support to speak to an agent to resolve the problem).

The events may also be classified within taxonomy. For example, supervisor escalation events may include escalations due to customer rudeness, agent rudeness, customer requesting resolution that requires supervisor authorization, customer requesting supervisor for impossible request, etc. This is challenging given that customer might express the same issue differently in a voice conversation versus a text conversation in a chat session and the two semantically equivalent events are mapped to the same topic in canonical taxonomy representation. This can be accomplished through semantic distance metrics such as the one described, for example, in U.S. patent application Ser. No. 14/586,730 “System and Method for Interactive Multi-Resolution Topic Detection and Tracking,” filed in the United States Patent and Trademark Office on Dec. 30, 2014, to map semantically similar events that might use different words to the same topic in a taxonomy.

In operation 330, the CX analytics module 47 generates the customer models 232 from the aggregated data. For example, every customer of the organization may be associated with a unique customer identifier (or customer id). All interactions associated with the particular customer (as identified by the customer id or as identified using other data such as telephone number or web browser configuration) are aggregated to form a customer model 232 for this particular customer. As noted above, these customer models 232 include data from all interactions with the contact center and therefore include information such as the timing of each of the customer's interactions with the organization, the timing of past purchases, the payment history, and amenability to sales offers.

In operation 330, the CX analytics module 47 may also generate the aggregated customer models 232c by aggregating groups of customers based on one or more shared traits. These traits may relate to, for example, geography (e.g., customers from the same city), order frequency (e.g., regular customers versus infrequent customers), customer tier (e.g., platinum members versus regular members), types of customers (e.g., end users versus resellers), and users of different products offered by the organization (e.g., customers who own one product versus those who own a different product).

In operation 330, the CX analytics module 47 generates the agent models 234 from the aggregated data. As discussed above, the agent models 234 are aggregations of agent data for each of the agents. For example, each agent may be associated with a unique agent identifier (or agent id) and every interaction associated with that agent id may be aggregated into the agent model 234 for a particular agent. As such, the agent model 234 contains sufficient historical information to compute, for example, the agent's first call resolution rate, hold time, sales performance, customer satisfaction scores, and other performance metrics. Furthermore, these performance metrics may be computed based on various conditions such as the interaction topic and/or classes of customers.

Similarly, in some embodiments of the present invention, in operation 330 the CX analytics module 47 may also compute the aggregated agent models 234c from the individual agent models 234 by aggregating the performance metrics of the various agents across various groups of agents. This aggregation may be computed by, for example calculating mean performance metrics across the agents within the group (e.g., the mean first call resolution time of the group).

In operation 340, the CX analytics module may generate a set of predictors 220 to predict customer and agent behavior based on the generated customer and agent models 232 and 234. The predictors 220 may correspond to deep neural networks (a deep neural network being a neural network that has more than one hidden layer) and the process of generating the predictors 220 may involve training the deep neural networks using the generated customer models 232, where the predictors 220 compute the probability that a particular customer will take a particular action (e.g., contact within a particular time frame over a particular channel or contact regarding a particular topic), based on the characteristics identified in the model 232. As such, the customer models 232 may be thought of as containing a list or set of features (e.g., a feature vector) and one or more of the features may be supplied as input features to the predictor 220, where the predictor 220 predicts the probability of an event not included in the set of input features. A predictor 220 may be trained for each group of customers (e.g., as divided by demographics as described above in the context of aggregated customer models 232c) and/or a predictor 220 may be trained for all customers as a whole. This training of the predictors 220 may be performed using, for example, the back propagation algorithm. Specific examples of the predictors 220 will be described in more detail below.

In operation 350, the generated predictors 220 may be used to forecast the behavior of individual customers and the customers as a whole. For example, the customer model 232 generated for a particular customer can be supplied as an input to a generated predictor 220 (e.g., a deep neural network), which will generate an output probability based on the supplied input. The prediction may be repeated for all customer models 232 to calculate a probability distribution of various events based on the current customer models 232. Similarly, the agent models 234 may be used to predict the capacity of the agents to handle the predicted load.

Based on determinations of the forecasted behavior of the customers and agents, the CX analytics module 47 may generate application settings in operation 360. While the application settings will generally differ based on the particular needs of the application to be configured, generally speaking, embodiments of the present invention make use of the predictors 220 to calculate probabilistic expected values (e.g., an expected call volume or a likelihood of a particular event). These predictions or calculated expected values are then applied to particular application-specific conditions (e.g., calculations specific to the application) to calculate the application parameters. For example, predictions of call volume during a future shift may be used to calculate an appropriate agent staffing for that shift to handle the predicted call volume.

These application settings may be for applications different from which the input data was collected in operation 310 and aggregated in operation 320. For example, data collected from a web server regarding a customer's activity on the organization's website may be used to predict the user's likely topics when calling in to speak to a human agent over the phone and therefore data collected from the web server (or a web analytics system) may affect the routing or work force management applications.

In operation 370, the CX analytics module 47 may output the calculated application settings and supply the settings to the appropriate module of the contact center to automatically reconfigure the module (and possibly the entire contact center) based on the predicted behavior of customers and agents. For example, a workforce management module may be reconfigured to allocate additional agents to particular shifts. As another example, self-help systems may be modified to promote and to make more prominent articles that are predicted to be in higher demand.

In addition, as discussed above, the process of collecting data and updating the customer models 232 and agent models 234 may be performed periodically or continuously, in other words, dynamically during runtime. For example, the customer models 232 and agent models 234 may be updated on a regular time interval such as weekly, daily, hourly, or every few minutes. As another example, the customer models 232 and agent models 234 may be updated substantially continuously, such as after each interaction is completed, or as events are detected in interactions. The aggregate models may also be updated contemporaneously when the individual customer models 232 and agent models 234 are updated. Similarly, the predictors can be updated (e.g., periodically or substantially continuously) with the updates of the customer models 232 and agent models 234, and the application parameters can therefore also be dynamically updated during runtime, such that the parameters of the applications of the contact center can be updated dynamically in accordance with current conditions detected in the interactions.

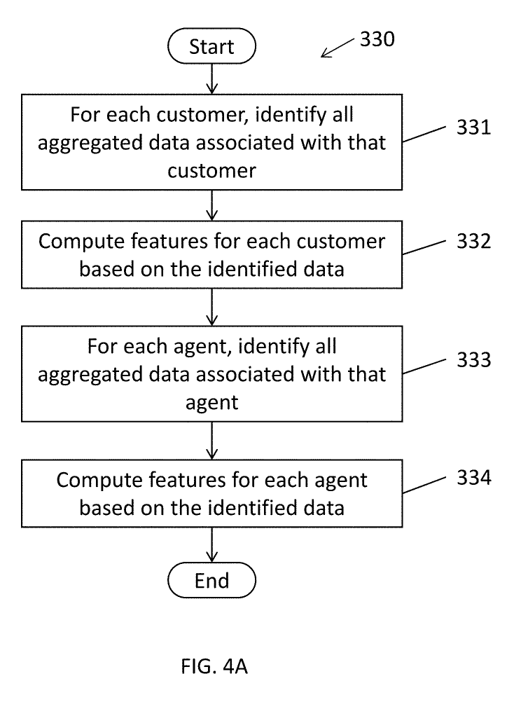

FIGS. 4A and 4B are flowcharts illustrating a method 330 for generating customer and agent models 232 and 234 and aggregated customer and agent models 232c and 234c according to one embodiment of the present invention. Referring to FIG. 4A, the customer experience analytics module 47 may use the data aggregated in operation 320 to generate the individual customer and agent models. In more detail, in operation 331, for each unique customer, the customer experience analytics module 47 identifies all data from the aggregated data that is associated with the customer. This may be, for example, all recorded interactions between the customer and the organization (e.g., emails, sales orders, conversation transcripts, etc.). In operation 332, for the identified data for each customer, a set of features or attributes is computed from the aggregated data. The features may include, for example, time since last contact with the organization, total value of all purchases by the customer, the presence of an unresolved issue, the frequency of contact between the customer and the organization, the status of the customer (e.g., platinum tier support), etc. These features may form a portion of the customer model 232 for that particular customer. In some embodiments, the features are not calculated at the time that the data is aggregated but instead are calculated at the time that the model is applied, such as when using the customer model 232 to train a predictor 220 or when predicting a feature of the customer model by supplying the features of the customer model as an input to a predictor 220.

In operation 333, in a manner similar to that used for generating the customer models 232, the customer experience analytics module 47 computes a plurality of individual agent models 234 by identifying all data from the aggregated data that is associated with the identified agent. This may be, for example, ail recorded interactions between the agent and any of the customers of the organization (e.g., emails, conversation transcripts, chat histories, etc.). In operation 334, for the identified data for each agent, a set of features or attributes is computed from the aggregated data. These features may include, for example, first call resolution for each of a number of interaction reasons, average handling time for each of the interaction reasons, and customer satisfaction for each of the interaction reasons. These agent specific features may form a portion of the agent model 234 for that particular agent.

Referring now to FIG. 4B, in operation 335, for each group of customers, the individual customer models are aggregated into an aggregate customer model corresponding to that group of customers. Examples of groups of customers include customers who live in a particular geographic region, customers who use a particular product line, and customers who are in a particular service tier. In addition, all customers may be aggregated into a group. For each of the groups, the features or attributes of the individual customers is combined (e.g., an average value is calculated such as a mean) to generate an aggregate customer model 232c corresponding to that group. As such, one or more aggregate customer models 232c are created in operation 335.

Similarly, in operation 336, for each group of agents, the individual agent models are aggregated into an aggregate customer model corresponding to that group of agents. Examples of groups of agents include: agents who work together on a particular shift, agents who have received additional training, agents who work at a particular site, and agents who service particular product lines. For each of the groups, the features or attributes of the individual agents (such as their first call resolution rates, average handling times, and customer satisfaction scores) are combined (e.g., an average value is calculated such as a mean) to generate an aggregate agent model 234c corresponding to that group. As such, one or more aggregate agent models 234c are created in operation 336.

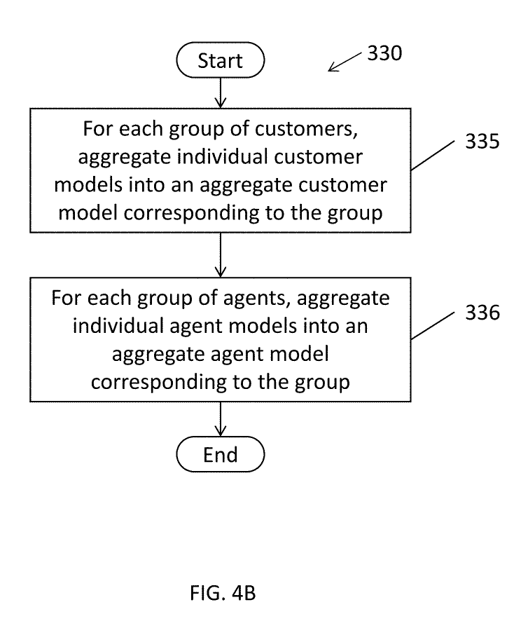

FIG. 5 is a flowchart illustrating a method 340 for generating predictors according to one embodiment of the present invention. The predictors 220 generally take the form of receiving an input customer model (e.g., an individual customer model or an aggregate customer model) and outputting a probability of a particular feature based on the input customer model. For example, a predictor 220 configured to predict the probability that a customer will call within the next week will receive an input customer model (e.g., including features such as whether the customer has contacted the organization in the past few days, whether the customer has recently had a change in service plan, and whether the customer has any issues that were not resolved in previous interactions with the organization) and output one or more probabilities of various events.

In some embodiments of the present invention, the predictors 220 are implemented using deep neural networks that are trained based on historical data. Continuing the above example, training data can be generated from the customer models 232. Assuming, for example, that the N features of a particular customer model can be represented as (x₁, x₂, . . . , x_{N}), as identified by user input or as identified by customer experience analytics system 47 (e.g., automatically identifying features that appear relevant or generating predictors for all features) in operation 342, and a goal is to predict an event E_{customer}_{_}_{call} (e.g., whether the customer will call in the next 48 hours), then each of the customer corresponding to a relevant group for the predictor (e.g., all customers, or all customers of a particular tier, or all customers using a particular product line) may be used to provide in operation 344, examples that make up the training data, where, for each example, the input portion of the training data is all of the features of the model except E_{customer}_{_}_{call} which is the output portion or the label of the training data (i.e., for the given customer that is associated with the input features the historical truth of whether he called or not in the 48 hour period that occurred in the past. This is usually labeled as 1 for the event happened and 0 for had not happened) of the training data. The training data is separated into a training set, a test set, and a validation set, as is well known in the art, and the back propagation algorithm may be used to train, in operation 346, a deep neural network (e.g., a neural network having an input layer, an output layer, and more than one hidden layer between the input layer and the output layer). The resulting trained neural network is a predictor for event E_{customer}_{_}_{call} (e.g., whether the given customer will call in the next 48 hours) and may then be output in operation 348 to be stored for later use in generating predictions.

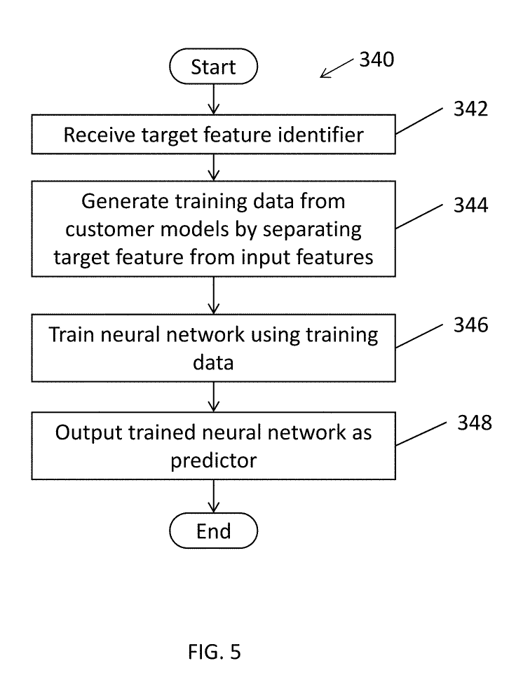

FIG. 6 is a flowchart illustrating a method 350 for forecasting behavior using the predictors according to one embodiment of the present invention. In operation 352, an input is received relating to the prediction or predictions to be made. These inputs include one or more customer models or aggregate customer models whose behavior is to be predicted, along with an identification of which predictor 220 to use (e.g., an identification of the feature that is to be predicted). Continuing the above example, to predict the probability that a particular customer will contact the organization in the next 48 hours, a predictor corresponding to “contact in the next 48 hours” will be selected along with the individual customer model corresponding to that customer. In operation 354, the input features associated with said customer serve as the inputs of the identified predictor (e.g., the features of the customer model are supplied to the input layer of a neural network). The predictor is then run in operation 356 to generate a probability of the event occurring (e.g., the probability of “contact in the next 48 hours”) based on the state of the customer (e.g., as identified by the customer model). The probability computed by the predictor is then output in operation 358. These operations of supplying a customer features to a predictor can be repeated for each combination of customer or aggregated customer and predictor, based on the predictions that may be needed for other operations.

One example of an application of a CX analytics module 47 according to embodiments of the present application is the automatic provisioning of cloud-based applications (e.g., applications hosted on servers on the internet). In particular, a CX analytics module 47 may be used to automatically tune cloud-based applications in a data driven fashion. Interaction data may be obtained from historical logs or may be collected in preparation for going live. The interaction data may then be used to predict customer demand and agent performance. The predictions may be used to tune applications such as routing, workforce management, and self-help in order to meet the predicted workloads and predicted patterns of customer behavior.

Another example of an application of a customer experience analytics module 47 according to embodiments of the present invention is the prediction of a customer's likely next action and to take a proactive action in response to the customer's next action or to personalize service when the customer next contacts the organization. For example, some customers may have a high probability of contacting the organization if they have an unusually high bill or if their previous interactions with the organization left issues unresolved. Rather than allow the customer to remain angry before contact, a customer experience analytics module 47 may automatically determine that the customer may be dissatisfied and identify the customer as one who should receive proactive contact from an appropriate agent or knowledge worker of the organization to resolve the issue.

These circumstances can be detected based on matching the current customer to customers in a similar situation who were upset (e.g., a predictor 220 may be a neural network trained to predict the probability of “customer dissatisfied” based on a plurality of customer attributes such as “unusually high bill,” “previous unresolved contact regarding billing,” and “consistent on-time payment.” This may be trained based on identifying prior historical interactions with customers and using features or attributes (e.g., a set or vector of features or attributes) of the customers other than the customer's dissatisfaction as the inputs and whether or not the customer is dissatisfied as the output.

Another example of next best action relates to customer life cycle state predictions. For example, customers who are in the state of being “happy and looking to buy more” can similarly be identified by a predictor 220 (e.g., a deep neural network) trained on examples of customers (e.g., described by the customer models 232 of attributes or features) and whether or not those customers accepted a sales offer regarding new products and/or upgrade options. As such, a predictor 220 of amenability to sales offer may take an input customer model 232 and output a probability that the customer will accept a sales offer.

As another example, self-help systems can be personalized based on predicted next actions by the customer. For example, based on a customer model 232 associated with short term activities, a customer who called a financial services organization to ask about 401k beneficiary changes but who did not take any action regarding such a change may be automatically offered the option to make such a change the next time the customer contacts the financial services organization.

### Application of Customer Experience Analytics to Workforce Management

As a more detailed example, in one embodiment of the present invention, a customer experience analytics module 47 may automatically control a workforce management system in order to schedule available agents to various shifts. Generally, based on predictions of interaction volume and interaction call reasons across the aggregated customers and predictions of agent first call resolution rates, average handling times, and other factors, agents can be scheduled to satisfy the predicted demand. As such, the predictions may be used to optimize scheduling based on predicted demand. These scheduling operations may also take into account agent vacation schedules, working hour restrictions (e.g., based on union agreements), and other organizational policy factors.

For the sake of convenience, notation for the below discussion will be introduced as follows:

S₁, S₂, . . . , Sₙ denote groups of agents having various skill combinations. For example, S₁ may refer to agents that can handle voice and chat, speak both English and Spanish, and are capable of addressing Customer Service and Billing at the first level (e.g., without escalation). S₂ may refer to agents that can handle voice only, and who can speak English and Mandarin Chinese, and who are capable of addressing Customer Service and Billing at the first level.

F₁, F₂, . . . Fₘ denote the various shifts that the agents can be scheduled to. For example, F_{L} may refer to a shift on Jan. 18, 2016 8 am PST 4 pm PST.

T₁, T₂, . . . , T_{y} denote the various customer interaction reasons (or intent) that the customer can have for interacting with the contact center. These call reasons may include, for example, “technical support for product A,” “purchase of product B,” “billing questions,” and “change of address.” In the below discussion, it is assumed that there is a mapping of each customer interaction reason Tᵢ to one or more agent skill combinations Sⱼ such that for every call reason one can identify a group of agents who can handle it based on the agent groups' skill combinations. The universe of customer interaction reasons for a particular organization can be determined by running speech analytics 45 (as described, for example, in U.S. patent application Ser. No. 14/586,730 “System and Method for Interactive Multi-Resolution Topic Detection and Tracking,” filed in the United States Patent and Trademark Office on Dec. 30, 2014, the entire disclosure of which is incorporated herein by reference) on the historical call recordings (e.g., call recordings in call recording storage 42) and finding all user interaction reasons that appear at least a threshold number of times.

Customer_{Fi} denotes the number of interactions for each call reason (T₁, T₂, . . . , T_{y}) during a particular shift Fᵢ in addition to the projected average length of each interaction (per call reason) based on the customer models 232 of the current customers. For the sake of convenience, the below analysis assumes that interactions are uniformly distributed across the shift Fᵢ. As one of ordinary skill in the art would understand, the assumption can be relaxed (e.g., by dividing the shifts into sub-shifts). Customer_{R} can be predicted using a trained predictor 220 as described in more detail below.

Agent_{Fi} denotes parameters such as the first call resolution rate and the average handling time for each call reason (T₁, T₂, . . . , T_{y}) during a particular shift Fᵢ based on the aggregated agent models 234c for the agents having each skill combination S. These can be computed by analyzing the records of agent-customer interactions to compute the performance of individual agents.

Given the above, a scheduling function Sched(Fⱼ, Customer_{Fj}, Agent_{Fj})→(A₁, A₂, . . . , Aₙ) takes as input a particular shift Fⱼ, and predictions Customer_{Fi}, and Agent_{Fi} for the shift Fᵢ and outputs a set of agents (A₁, A₂, . . . , Aₙ) having the skill combinations to handle the predicted interaction volume of shift Fᵢ.

According to one embodiment, one manner of generating the Customer_{Fi} is to train a deep neural network using deep learning. The output of such a neural network is the probability that a customer will contact an organization about a specific interaction reason T during a certain shift F. According to one embodiment, one deep learning network is trained for all interaction reasons T, but embodiments of the present invention are not limited thereto and, as would be understood by one of skill in the art, for example, separate neural networks may be trained for each call reason or for other parameters.

In some embodiments of the present invention, the features (or attributes or parameters) supplied to the predictor 220 may include: the number of times the customer contacted the organization regarding each call reason (T₁, T₂, . . . , T_{y}) in the past 48 hours; the number of times the customer contacted the organization regarding each call reason (T₁, T₂, . . . , T_{y}) in the past 30 days; the number of times the customer contacted the organization regarding any call reason in the past 30 days; the prior of customers in general contacting the organization about each call reason (T₁, T₂, . . . , T_{y}) (e.g., probability that any customer will contact the organization regarding each call reason); and whether the customer had a change in account or service over the past week.

However, as would be understood by one of skill in the art, embodiments of the present invention are not limited to predictors 220 using the above identified inputs and may exclude one or more of those inputs or may include additional inputs not specifically listed above. For example, the time periods may be varied and other parameters, such as whether the customer was recently contacted by the organization or whether the customer has an unresolved issue regarding a particular topic, may also be used as inputs to the predictor 220.

Based on this trained neural network, Sched(Fⱼ, Customer_{Fj}, Agent_{Fj})→(A₁, A₂, . . . , Aₙ) can be calculated by predicting the volume of customer interactions Customer_{Fi} and their associated interaction reasons T for a particular shift Fᵢ, predicting agent capabilities Agent_{Fi}, and identifying constraints such as desired maximum hold time, average handling time, first call resolution rate to determine the minimum number of agents (A₁, A₂, . . . , Aₙ) having the necessary skills S to satisfy the constraints.

In some embodiments of the present invention, the trained neural network may also have one or more inputs that represent characteristics of customer interactions during a previous period (e.g., a previous shift), such as interaction volume, distribution of issues, and one or more error or difference values between the actual traffic in the previous period and the predicted traffic in the previous period. In other embodiments of the present invention, the predicted volume of customer interactions output by the neural network is adjusted by the volume and characteristics (e.g., by scaling the prediction based on the ratio of the actual volume and predicted volume in the previous period).

### Application of Customer Experience Analytics to Routing

As another more detailed example, in one embodiment of the present invention, a customer experience analytics module 47 may automatically control a routing server (e.g., routing server 20) to predict a customer's reason for contacting the organization and to automatically route a customer to an appropriate agent.

Generally, when a known customer contacts a contact center, for example, through text chat or by telephone, without specifying a reason, an agent is chosen by the agent's general or average quality of response. However, if the call reason were known in advance, then an agent may be selected based on the agent's ability to handle the particular call reason (e.g., some agents may be better at handling support questions related to one product line than another product line). Therefore, it is generally more efficient to route a customer to an agent who is well suited to address the customer's reasons for contacting the organization.

For the sake of convenience, notation for the below discussion will be introduced as follows:

Cust₁, Cust₂, . . . , Cust_{M} are the individual customers of the organization.

Agent₁, Agent₂, . . . Agent_{f} are the individual agents populating a particular shift.

Route(Custₖ, Agents)→Agentᵢ identifies an agent (Agent) from among all agents (Agents) in terms of predicted performance metric such as average handling time, first call resolution, and customer satisfaction for the predicted interaction reason of the customer Custₖ who has initiated contact with the contact center. The predicted interaction reason for Custₖ can be predicted using a trained predictor 220, which will be described in more detail below.

In the below example, the routing of an interaction to a particular agent may be computed based on the agent's first call resolution rate for the interaction reason associated with the incoming interaction. However, embodiments of the present invention are not limited thereto and an agent may be identified using other performance characteristics or multiple performance characteristics (e.g., average handling time and/or customer satisfaction). In some embodiments of the present invention, an agent may also be identified in accordance with one or more agent performance characteristics (e.g., agent idle time, average difficulty or complexity of calls, agent skills, and agent activity patterns). In some embodiments of the present invention, an agent may be identified based on the existence of previous positive interactions with the same customer (e.g., where a customer may have developed rapport with a particular agent).

According to one embodiment of the present invention, the trained predictor 220 is a deep neural network having one output node for each interaction reason (T₁, T₂, . . . , T_{y}). The neural network may be trained with a softmax loss function (or a similar cost function) so that the neural network estimates the posterior probability that a specific customer (e.g., a customer specified by the customer's features or attributes which are the inputs to the neural network) will contact the organization regarding each of the interaction reasons (T₁, T₂, . . . , T_{y}).

In some embodiments of the present invention, the features (or attributes or parameters) supplied to the predictor 220 may include: the number of times the customer contacted the organization regarding each call reason (T₁, T₂, . . . , T_{y}) in the past 48 hours that were resolved; the number of times the customer contacted the organization regarding each call reason (T₁, T₂, . . . , T_{y}) in the past 48 hours that were not resolved; the number of times the customer contacted the organization regarding each call reason (T₁, T₂, . . . , T_{y}) in the past 30 days that were resolved; the number of times the customer contacted the organization regarding each call reason (T₁, T₂, . . . , T_{y}) in the past 30 days that were not resolved; and the prior of customers in general contacting the organization about each call reason (T₁, T₂, . . . , T_{y}) (e.g., probability that any customer will contact the organization regarding each call reason).

However, as would be understood by one of skill in the art, embodiments of the present invention are not limited to predictors 220 using the above identified inputs and may exclude one or more of those inputs or may include additional inputs not specifically listed above. For example, the time periods may be varied and other parameters, such as whether the customer was recently contacted by the organization or whether the customer has an unresolved issue regarding a particular topic, may also be used as inputs to the predictor 220.

Training a neural network based on historical data of the above input features and the actual historical results of whether or not those customers contacted the organization regarding each of those call reasons generates the above described predictor 220, which maps from input features describing a particular customer to probabilities of contacting the organization for each of interaction reasons. As such, when a customer initiates a contact with an organization, after identifying the customer model 232 associated with the customer, the customer model 232 can be supplied to the trained predictor 220 to compute a plurality of probabilities (or posterior probability distribution) corresponding to the possible interaction reasons and a highest probability interaction reason is identified from among the plurality of probabilities.

The identified highest probability interaction reason is then used to identify an available agent having the skills for effective resolution of the given interaction reason. In more detail, to estimate Route(Custₖ, Agents) based on optimizing first call resolution (although embodiments are not limited thereto), first the probability that the incoming interaction relates to interaction reason Tj given that the interaction is from customer Custₖ is estimated using the neural network (P(Tj|Custₖ)). In addition, the agent's first call resolution rate for the interaction reason Tⱼ is Agent_{j,FCR(Tj)}. As such, an agent can be identified by minimizing across all available agents:

$${\sum }_{j} {Agent}_{i , FCR ( Ti )} P ( {T}_{j} \vert {Cust}_{k} )$$

In other words, given the customer posterior probability for each interaction reason Tⱼ, an agent “weighted” performance is calculated by multiplying the expected value of each agent in terms of performance metric (in this example, first call resolution, where a “low” first call resolution indicates good performance) and routing to the agent that minimizes this performance metric.

In addition, in some embodiments of the present invention, when agent satisfaction is one factor in the optimization for routing an interaction, an average interaction issue complexity may be used, such that agents who have recently handled one or more “difficult” interactions (e.g., unusual issue requiring a creative solution, irate customer, or a complex task) may be assigned an interaction that is predicted to be “easy” (e.g., simple resolution of a common issue). In other embodiments of the present invention, factors such as reducing the frequency of agent activity changes, avoiding activity changes too shortly after breaks, reducing context switching if an agent is assigned to multiple activities (e.g., an agent assigned to technical support, billing, and sales), taking an agent's activity preferences into account, identifying a match based on agent preferences and customer preferences (e.g., based on the individual customer model 232i), and considering how an agent fits into the agent group of a given activity (e.g., whether the agent is relevant for conference, consult, or transfer).

Some aspects of embodiments of the present invention are directed to many-to-many routing, in which routing decisions are made based on a set of currently waiting interactions (e.g., incoming communications from customers, such as voice calls, chat sessions, and emails) and an overall best match is made between the set of available agents and the set of waiting interactions in accordance with the predictions made by the predictors 220 in accordance with the customer models 232 and the agent models 234.

In some embodiments of the present invention, the pacing of routing interactions to agents and the identification of which agent to route the interactions to may depend on smoothing transitions between different states of the contact center. For example, when reassigning agents to new, different activities in order to account for higher than expected demand for a particular service (e.g., unexpected increase in technical support interactions) or in accordance with external regulations (e.g., government regulations regarding the connection rate of outbound calls), the reassignment may cause problems in the contact center capacity if it is performed too suddenly or abruptly. For example, a sudden shift away from an area may cause customers to suddenly see a drastic increase in estimated time to their interaction request being answered, thereby potentially causing customer dissatisfaction. Therefore, in some embodiments of the present invention, the CX analytics system 47 can control the routing system to smoothly transition agents from one activity to another, such as by allowing the agent to finish the interaction that he or she is currently handling, adjusting the pacing of the outbound contacts, adjusting the estimated wait time, and generally avoiding frequent changes at the agent level.

### Computing Devices

As described herein, various applications and aspects of the present invention may be implemented in software, firmware, hardware, and combinations thereof. When implemented in software, the software may operate on a general purpose computing device such as a server, a desktop computer, a tablet computer, a smartphone, or a personal digital assistant. Such a general purpose computer includes a general purpose processor and memory.

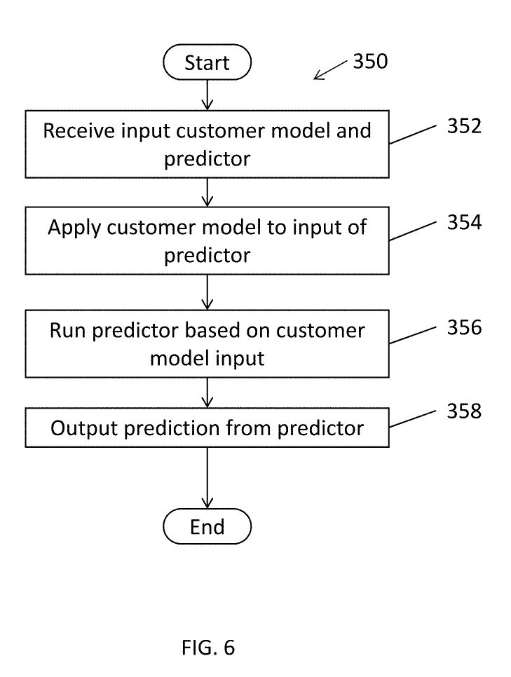

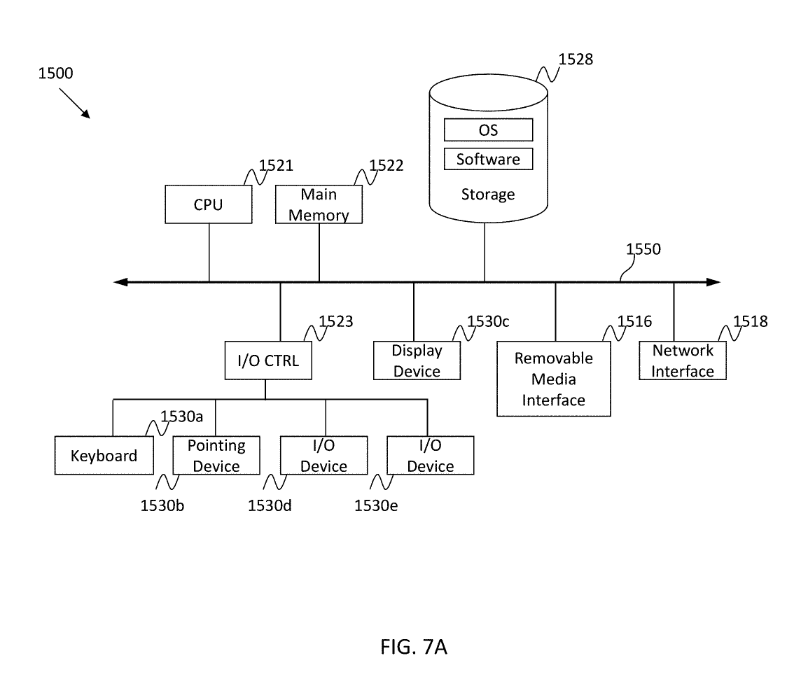

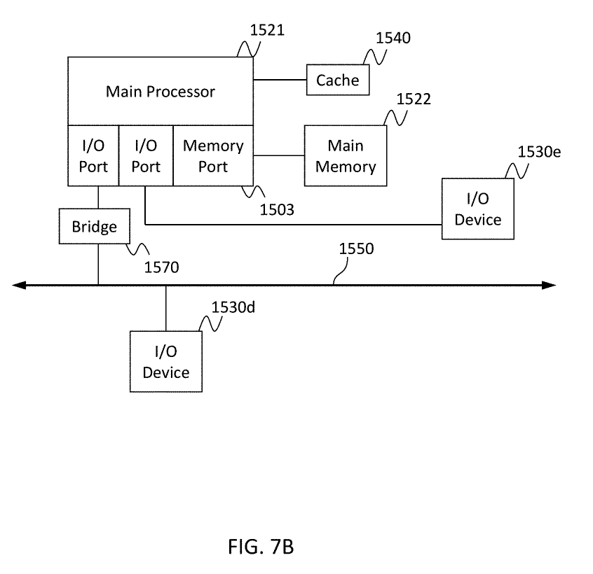

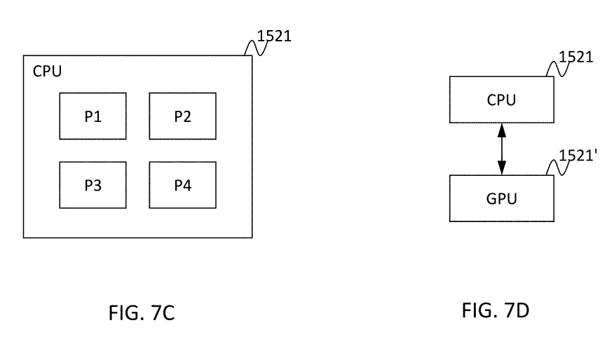

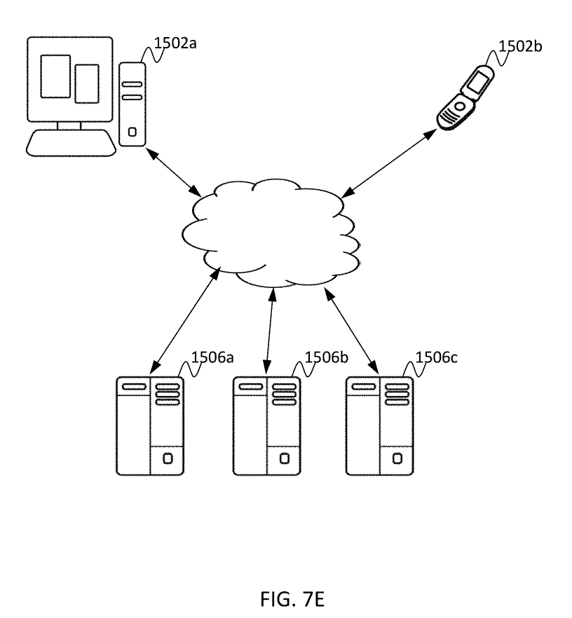

Each of the various servers, controllers, switches, gateways, engines, and/or modules (collectively referred to as servers) in the afore-described figures may be a process or thread, running on one or more processors, in one or more computing devices 1500 (e.g., FIG. 7A, FIG. 7B), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that a computing device may be implemented via firmware (e.g., an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers, and other modules.

The various servers may be located on a computing device on-site at the same physical location as the agents of the contact center or may be located off-site (or in the cloud) in a geographically different location, e.g., in a remote data center, connected to the contact center via a network such as the Internet. In addition, some of the servers may be located in a computing device on-site at the contact center while others may be located in a computing device off-site, or servers providing redundant functionality may be provided both via on-site and off-site computing devices to provide greater fault tolerance. In some embodiments of the present invention, functionality provided by servers located on computing devices off-site may be accessed and provided over a virtual private network (VPN) as if such servers were on-site, or the functionality may be provided using a software as a service (SaaS) to provide functionality over the internet using various protocols, such as by exchanging data using encoded in extensible markup language (XML) or JavaScript Object notation (JSON).

FIG. 7A-FIG. 7B depict block diagrams of a computing device 1500 as may be employed in exemplary embodiments of the present invention. Each computing device 1500 includes a central processing unit 1521 and a main memory unit 1522. As shown in FIG. 7A, the computing device 1500 may also include a storage device 1528, a removable media interface 1516, a network interface 1518, an input/output (I/O) controller 1523, one or more display devices 1530c, a keyboard 1530a and a pointing device 1530b, such as a mouse. The storage device 1528 may include, without limitation, storage for an operating system and software. As shown in FIG. 7B, each computing device 1500 may also include additional optional elements, such as a memory port 1503, a bridge 1570, one or more additional input/output devices 1530d, 1530e and a cache memory 1540 in communication with the central processing unit 1521. The input/output devices 1530a, 1530b, 1530d, and 1530e may collectively be referred to herein using reference numeral 1530.

The central processing unit 1521 is any logic circuitry that responds to and processes instructions fetched from the main memory unit 1522. It may be implemented, for example, in an integrated circuit, in the form of a microprocessor, microcontroller, or graphics processing unit (GPU), or in a field-programmable gate array (FPGA) or application-specific integrated circuit (ASIC). The main memory unit 1522 may be one or more memory chips capable of storing data and allowing any storage location to be directly accessed by the central processing unit 1521. As shown in FIG. 7A, the central processing unit 1521 communicates with the main memory 1522 via a system bus 1550. As shown in FIG. 7B, the central processing unit 1521 may also communicate directly with the main memory 1522 via a memory port 1503.

FIG. 7B depicts an embodiment in which the central processing unit 1521 communicates directly with cache memory 1540 via a secondary bus, sometimes referred to as a backside bus. In other embodiments, the central processing unit 1521 communicates with the cache memory 1540 using the system bus 1550. The cache memory 1540 typically has a faster response time than main memory 1522. As shown in FIG. 7A, the central processing unit 1521 communicates with various I/O devices 1530 via the local system bus 1550. Various buses may be used as the local system bus 1550, including a Video Electronics Standards Association (VESA) Local bus (VLB), an Industry Standard Architecture (ISA) bus, an Extended Industry Standard Architecture (EISA) bus, a MicroChannel Architecture (MCA) bus, a Peripheral Component Interconnect (PCI) bus, a PCI Extended (PCI-X) bus, a PCI-Express bus, or a NuBus. For embodiments in which an I/O device is a display device 1530c, the central processing unit 1521 may communicate with the display device 1530c through an Advanced Graphics Port (AGP). FIG. 7B depicts an embodiment of a computer 1500 in which the central processing unit 1521 communicates directly with I/O device 1530e. FIG. 7B also depicts an embodiment in which local busses and direct communication are mixed: the central processing unit 1521 communicates with I/O device 1530d using a local system bus 1550 while communicating with I/O device 1530e directly.

A wide variety of I/O devices 1530 may be present in the computing device 1500. Input devices include one or more keyboards 1530a, mice, trackpads, trackballs, microphones, and drawing tablets. Output devices include video display devices 1530c, speakers, and printers. An I/O controller 1523, as shown in FIG. 7A, may control the I/O devices. The I/O controller may control one or more I/O devices such as a keyboard 1530a and a pointing device 1530b, e.g., a mouse or optical pen.

Referring again to FIG. 7A, the computing device 1500 may support one or more removable media interfaces 1516, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 1530 may be a bridge between the system bus 1550 and a removable media interface 1516.

The removable media interface 1516 may for example be used for installing software and programs. The computing device 1500 may further include a storage device 1528, such as one or more hard disk drives or hard disk drive arrays, for storing an operating system and other related software, and for storing application software programs. Optionally, a removable media interface 1516 may also be used as the storage device. For example, the operating system and the software may be run from a bootable medium, for example, a bootable CD.

In some embodiments, the computing device 1500 may include or be connected to multiple display devices 1530c, which each may be of the same or different type and/or form. As such, any of the I/O devices 1530 and/or the I/O controller 1523 may include any type and/or form of suitable hardware, software, or combination of hardware and software to support, enable or provide for the connection to, and use of, multiple display devices 1530c by the computing device 1500. For example, the computing device 1500 may include any type and/or form of video adapter, video card, driver, and/or library to interface, communicate, connect, or otherwise use the display devices 1530c. In one embodiment, a video adapter may include multiple connectors to interface to multiple display devices 1530c. In other embodiments, the computing device 1500 may include multiple video adapters, with each video adapter connected to one or more of the display devices 1530c. In some embodiments, any portion of the operating system of the computing device 1500 may be configured for using multiple display devices 1530c. In other embodiments, one or more of the display devices 1530c may be provided by one or more other computing devices, connected, for example, to the computing device 1500 via a network. These embodiments may include any type of software designed and constructed to use the display device of another computing device as a second display device 1530c for the computing device 1500. One of ordinary skill in the art will recognize and appreciate the various ways and embodiments that a computing device 1500 may be configured to have multiple display devices 1530c.

A computing device 1500 of the sort depicted in FIG. 7A-FIG. 7B may operate under the control of an operating system, which controls scheduling of tasks and access to system resources. The computing device 1500 may be running any operating system, any embedded operating system, any real-time operating system, any open source operating system, any proprietary operating system, any operating systems for mobile computing devices, or any other operating system capable of running on the computing device and performing the operations described herein.

The computing device 1500 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 1500 may have different processors, operating systems, and input devices consistent with the device.

In other embodiments the computing device 1500 is a mobile device, such as a Java-enabled cellular telephone or personal digital assistant (PDA), a smart phone, a digital audio player, or a portable media player. In some embodiments, the computing device 1500 includes a combination of devices, such as a mobile phone combined with a digital audio player or portable media player.

As shown in FIG. 7C, the central processing unit 1521 may include multiple processors P1, P2, P3, P4, and may provide functionality for simultaneous execution of instructions or for simultaneous execution of one instruction on more than one piece of data. In some embodiments, the computing device 1500 may include a parallel processor with one or more cores. In one of these embodiments, the computing device 1500 is a shared memory parallel device, with multiple processors and/or multiple processor cores, accessing all available memory as a single global address space. In another of these embodiments, the computing device 1500 is a distributed memory parallel device with multiple processors each accessing local memory only. In still another of these embodiments, the computing device 1500 has both some memory which is shared and some memory which may only be accessed by particular processors or subsets of processors. In still even another of these embodiments, the central processing unit 1521 includes a multicore microprocessor, which combines two or more independent processors into a single package, e.g., into a single integrated circuit (IC). In one exemplary embodiment, depicted in FIG. 7D, the computing device 1500 includes at least one central processing unit 1521 and at least one graphics processing unit 1521′.

In some embodiments, a central processing unit 1521 provides single instruction, multiple data (SIMD) functionality, e.g., execution of a single instruction simultaneously on multiple pieces of data. In other embodiments, several processors in the central processing unit 1521 may provide functionality for execution of multiple instructions simultaneously on multiple pieces of data (MIMD). In still other embodiments, the central processing unit 1521 may use any combination of SIMD and MIMD cores in a single device.

A computing device may be one of a plurality of machines connected by a network, or it may include a plurality of machines so connected. FIG. 7E shows an exemplary network environment. The network environment includes one or more local machines 1502a, 1502b (also generally referred to as local machine(s) 1502, client(s) 1502, client node(s) 1502, client machine(s) 1502, client computer(s) 1502, client device(s) 1502, endpoint(s) 1502, or endpoint node(s) 1502) in communication with one or more remote machines 1506a, 1506b, 1506c (also generally referred to as server machine(s) 1506 or remote machine(s) 1506) via one or more networks 1504. In some embodiments, a local machine 1502 has the capacity to function as both a client node seeking access to resources provided by a server machine and as a server machine providing access to hosted resources for other clients 1502a, 1502b. Although only two clients 1502 and three server machines 1506 are illustrated in FIG. 7E, there may, in general, be an arbitrary number of each. The network 1504 may be a local-area network (LAN), e.g., a private network such as a company Intranet, a metropolitan area network (MAN), or a wide area network (WAN), such as the Internet, or another public network, or a combination thereof.

The computing device 1500 may include a network interface 1518 to interface to the network 1504 through a variety of connections including, but not limited to, standard telephone lines, local-area network (LAN), or wide area network (WAN) links, broadband connections, wireless connections, or a combination of any or all of the above. Connections may be established using a variety of communication protocols. In one embodiment, the computing device 1500 communicates with other computing devices 1500 via any type and/or form of gateway or tunneling protocol such as Secure Socket Layer (SSL) or Transport Layer Security (TLS). The network interface 1518 may include a built-in network adapter, such as a network interface card, suitable for interfacing the computing device 1500 to any type of network capable of communication and performing the operations described herein. An I/O device 1530 may be a bridge between the system bus 1550 and an external communication bus.

According to one embodiment, the network environment of FIG. 7E may be a virtual network environment where the various components of the network are virtualized. For example, the various machines 1502 may be virtual machines implemented as a software-based computer running on a physical machine. The virtual machines may share the same operating system. In other embodiments, different operating system may be run on each virtual machine instance. According to one embodiment, a “hypervisor” type of virtualization is implemented where multiple virtual machines run on the same host physical machine, each acting as if it has its own dedicated box. Of course, the virtual machines may also run on different host physical machines.

Other types of virtualization is also contemplated, such as, for example, the network (e.g. via Software Defined Networking (SDN)). Functions, such as functions of the session border controller and other types of functions, may also be virtualized, such as, for example, via Network Functions Virtualization (NFV).

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method for generating a predictor of customer behavior for a contact center, the method comprising:
collecting, by a processor, data from a plurality of different applications of the contact center, the data being stored in a plurality of different formats, the data corresponding to a plurality of recorded interactions between a plurality of customers and the contact center;
converting, by the processor, the data from the plurality of different formats into a common format;
generating, by the processor, a plurality of customer models for the customers by, for each customer of the customers:
identifying, from the data from the plurality of different applications, identified data associated with the customer; and
aggregating the identified data in an individual customer model of the plurality of customer models, the individual customer model being associated with the customer; and
generating, by the processor, a predictor in accordance with the customer models.

2. The method of claim 1, wherein the predictor is a deep neural network, and
wherein training the predictor in accordance with the customer models comprises:
calculating, for each of the customer models, a plurality of features;
identifying a target feature among the plurality of features;
generating training data, the training data comprising a plurality of examples, each of the examples comprising:
a plurality of input features corresponding to the plurality of features without the target feature; and
at least one output feature corresponding to the target feature; and
training the deep neural network in accordance with the training data by applying a back propagation algorithm.

3. The method of claim 1, wherein the generating the plurality of customer models for the customers further comprises, for each customer of the customers, generating a plurality of features in accordance with the identified data.

4. The method of claim 1, further comprising generating, by the processor, an aggregate customer model by:
identifying one or more individual customer models associated with a group; and
aggregating the one or more individual customer models to generate the aggregated customer model.

5. The method of claim 1, further comprising:
receiving, by the processor, additional data from one of the plurality of different applications of the contact center;
converting, by the processor, the additional data into the common format;
updating, by the processor, at least one of the plurality of customer models in accordance with the additional data to compute at least one updated customer model; and
updating, by the processor, the predictor in accordance with the at least one updated customer model.

6. A method for configuring a contact center, the method comprising:
supplying, by a processor, one or more customer models to a predictor, each of the one or more customer models comprising data collected from a plurality of different applications of the contact center;
computing, by the processor, an expected characteristic of future interactions in accordance with the one or more customer models; and
computing, by the processor and in accordance with the expected characteristic of future interactions, at least one configuration parameter for configuring an application of the different applications of the contact center.

7. The method of claim 6, wherein the predictor is a deep neural network.

8. The method of claim 6, wherein the customer models are generated by:
collecting, by the processor, data from the plurality of different applications of the contact center, the data being stored in a plurality of different formats, the data corresponding to a plurality of recorded interactions between a plurality of customers and the contact center;
converting, by the processor, the data from the plurality of different formats into a common format; and
generating, by the processor, the customer models for the customers by, for each customer of the customers:
identifying, from the data from the plurality of different applications, identified data associated with the customer; and
aggregating the identified data in an individual customer model of the customer models, the individual customer model being associated with the customer.

9. The method of claim 8, wherein the one or more customer models comprise an aggregated customer model, the aggregated customer model being generated by:
identifying a group of one or more individual customer models of the individual customer models; and
aggregating the group of one or more individual customer models to generate the aggregated customer model.

10. The method of claim 8, further comprising:
receiving, by the processor, additional data from one of the plurality of different applications of the contact center;
converting, by the processor, the additional data into the common format;
updating, by the processor, at least one of the one or more customer models in accordance with the additional data to compute at least one updated customer model; and
updating, by the processor, the predictor in accordance with the at least one updated customer model.

11. The method of claim 6, wherein the computing the at least one configuration parameter for configuring the application of the different applications of the contact center further comprises computing the at least one configuration parameter in accordance with a plurality of agent models, each of the agent models comprising data collected from the plurality of different applications of the contact center.

12. The method of claim 11, wherein the plurality of agent models are generated by:
collecting, by the processor, data from a plurality of different applications of the contact center, the data being stored in a plurality of different formats, the data corresponding to a plurality of recorded interactions between a plurality of agents of the contact center and a plurality of customers;
converting, by the processor, the data from the plurality of different formats into a common format; and
generating, by the processor, the plurality of agent models for the agents by, for each agent of the agents:
identifying, from the data from the plurality of different applications, identified data associated with the agent; and
aggregating the identified data in an individual agent model of the plurality of agent models, the individual agent model being associated with the agent.

13. The method of claim 12, wherein the plurality of agent models comprise an aggregate agent model, the aggregated agent model being generated by:
identifying a group of one or more individual agent models of the individual agent models; and
aggregating the group of one or more individual agent models to generate the aggregated agent model.

14. The method of claim 11, wherein each of the plurality of agent models comprises a first call resolution rate, an average handling time, and a customer satisfaction rating.

15. A system for operating a contact center comprising a plurality of different applications, the system comprising:
a processor; and
a memory, wherein the memory stores instructions that, when executed by the processor, cause the processor to:
supply one or more customer models to a predictor, each of the one or more customer models comprising data collected from the plurality of different applications;
compute an expected characteristic of future interactions in accordance with the one or more customer models; and
compute, in accordance with the expected characteristic of future interactions, at least one configuration parameter for configuring an application of the applications of the contact center.

16. The system of claim 15, wherein the predictor is a deep neural network.

17. The system of claim 15, wherein the memory further stores instructions that, when executed by the processor, cause the processor to generate the customer models by:
collecting data from the plurality of different applications of the contact center, the data being stored in a plurality of different formats, the data corresponding to a plurality of recorded interactions between a plurality of customers and the contact center;
converting the data from the plurality of different formats into a common format; and
generating the customer models for the customers by, for each customer of the customers:
identifying, from the data from the plurality of different applications, identified data associated with the customer; and
aggregating the identified data in an individual customer model of the customer models, the individual customer model being associated with the customer.

18. The system of claim 17, wherein the one or more customer models comprise an aggregated customer model, the aggregated customer model being generated by:
identifying a group of one or more individual customer models of the individual customer models; and
aggregating the group of one or more individual customer models to generate the aggregated customer model.

19. The system of claim 17, wherein the memory further stores instructions that, when executed by the processor, cause the processor to:
receive additional data from one of the plurality of different applications of the contact center;
convert the additional data into the common format;
update at least one of the one or more customer models in accordance with the additional data to compute at least one updated customer model; and
update the predictor in accordance with the at least one updated customer model.

20. The system of claim 15, wherein the memory further stores instructions that, when executed by the processor, cause the processor to compute the at least one configuration parameter for configuring the application of the different applications of the contact center by computing the at least one configuration parameter in accordance with a plurality of agent models, each of the agent models comprising data collected from the plurality of different applications of the contact center.

21. The system of claim 20, wherein the memory further stores instructions that, when executed by the processor, cause the processor to generate the plurality of agent models by:
collecting, by the processor, data from a plurality of different applications of the contact center, the data being stored in a plurality of different formats, the data corresponding to a plurality of recorded interactions between a plurality of agents of the contact center and a plurality of customers;
converting the data from the plurality of different formats into a common format; and
generating the plurality of agent models for the agents by, for each agent of the agents:
identifying, from the data from the plurality of different applications, identified data associated with the agent; and
aggregating the identified data in an individual agent model of the plurality of agent models, the individual agent model being associated with the agent.
